(19) United States
(12) Patent Application Publication
(10) Pub. No.: US 2023/0145011 A1
(43) Pub. Date: May 11, 2023

(54) FAN AND ELECTRIC HAIR DRYER WITH IMPROVED AIR OUTLET PERFORMANCE

(71) Applicant: DREAME TECHNOLOGY (SHANGHAI) CO., LTD., Shanghai City (CN)

(72) Inventors: TONG YANG, Shanghai City (CN); ZHENJIE HUANG, Shanghai City (CN); WENMING NIE, Shanghai City (CN); CHAOMIN SHU, Shanghai City (CN)

(21) Appl. No.: 17/910,817

(22) PCT Filed: May 13, 2021
(86) PCT No.: PCT/CN2021/093479

§ 371 Date: Sep. 11, 2022

(30) Foreign Application Priority Data
May 15, 2020 (CN) 202010411305.5
May 15, 2020 (CN) 202010411320.1
May 15, 2020 (CN) 202020808488.1
May 15, 2020 (CN) 202020808489.6

(51) Int. Cl. A45D 20/12; F04D 29/66; F04D 29/38; F04D 29/54

(52) U.S. Cl. CPC A45D 20/12; F04D 29/661; F04D 29/384; F04D 29/547

(57) ABSTRACT

A fan includes an air cylinder and an air outlet hood. An interior of the air cylinder is hollow to form a hollow cavity. The air cylinder has an air inlet and an air outlet. The air outlet hood is detachably disposed on the air outlet. The air outlet hood is provided with an annular air outlet for air outlet. An outer ring and/or an inner ring of the annular air outlet is formed with an annular guide rib extending toward the air inlet. The annular guide rib is configured to make an airflow cross section adjacent to the annular air outlet gradually decrease, so as to make an airflow in the air outlet hood cohesive, thereby increasing an air outlet speed of the annular air outlet. A hair dryer having the fan is also disclosed.

### TECHNICAL FIELD

The present application relates to a technical field of household appliances, in particular to a fan and an electric hair dryer.

### BACKGROUND

A hair dryer dries by generating wind with a specific temperature. After the hair dryer is powered on, a motor drives fan blades of a fan to rotate, and the air is sucked in from an air inlet. Heated by an electric heating element, the air is blown out from an air outlet after forming hot air. The fan is an important part of the hair dryer.

### SUMMARY

In view of the deficiencies in the existing technologies, the present application provides a fan and a hair dryer, which can improve the air outlet performance.

In order to solve the above-mentioned technical problem, the present application adopts the following technical solution:

a fan including: an air cylinder, an interior of the air cylinder being hollow along an axial direction of the air cylinder to form a hollow cavity which extends through the air cylinder, the air cylinder having an air inlet and an air outlet; an air impeller, disposed inside the air cylinder and is configured for blowing the air cylinder to form a high-speed airflow; and a guide vane assembly, disposed inside the air cylinder and adjacent to the air impeller, the guide vane assembly being configured to rectify an airflow entering the air cylinder; wherein along an air inlet direction from the air inlet to the air outlet, an inner wall of the air cylinder includes an air inlet section, a socket section and an air outlet section which are connected in sequence; and the air impeller and the guide vane assembly are disposed on the socket section; the air inlet section is provided with a constriction area, the constriction area extends to form the air inlet, and the constriction area is configured to depressurize the airflow entering the air impeller; the air outlet section is provided with a flared area, the flared area extends to form the air outlet, and the flared area is configured to diffuse the airflow out of the guide vane assembly.

Preferably, the air inlet section includes: a first flat straight area substantially parallel to the axial direction of the air cylinder; and a first inclined surface area connected with the first flat straight area and the socket section, respectively; and the first inclined surface area and the axial direction of the air cylinder are disposed at a first included angle to form the constriction area; wherein the first inclined surface area is farther from the air inlet than the first flat straight area.

Preferably, the socket section includes a second flat straight area and a third flat straight area which are substantially parallel to the axial direction of the air cylinder; the second flat straight area is connected with the first inclined surface area and the third flat straight area, respectively; wherein the second flat straight area is farther from the air outlet section than the third flat straight area, a diameter of the second flat straight area is smaller than a diameter of the first flat straight area, the air impeller is mounted on the second flat straight area, and the guide vane assembly is mounted on the third flat straight area.

Preferably, the air outlet section includes: a fourth flat straight area substantially parallel to the axial direction of the air cylinder; and a second inclined surface area connected with the third flat straight area and the fourth flat straight area, respectively; the second inclined surface area and the axial direction of the air cylinder are disposed at a second included angle to form the flared area; wherein the second inclined surface area is farther from the air outlet than the fourth flat straight area, and a diameter of the fourth flat straight area is larger than a diameter of the third flat straight area.

Preferably, the constriction area is an arc or an arc chain formed by smooth connection of a plurality of arcs; or the constriction area is a straight line or a polyline formed by a plurality of straight lines.

Preferably, the air impeller is disposed adjacent to the air inlet section, the air impeller includes a wheel hub connected with an output shaft of a motor and a plurality of blades disposed on an outer wall of the wheel hub at equal intervals along a circumferential direction of the wheel hub, the number of the blades is n1; wherein the blades are configured such that a section in the circumferential direction of the wheel hub is arc-shaped, and a chord length B corresponding to the section increases as a diameter D of the blade increases; the number n1 of the blades, the chord length B and the diameter D of the blade satisfy the following relationship: 0.35<(B*n1/D)<0.48.

Preferably, the blade has a blade root connected to the wheel hub and a blade tip disposed away from the blade root; and wherein a gap between the blade tip and the inner wall of the air cylinder gradually decreases along the air inlet direction.

Preferably, the wheel hub is connected with the output shaft of the motor through a knurled nut; wherein an outer diameter of the wheel hub is gradually increasing in the air inlet direction, and a projection of an outer peripheral surface of the wheel hub in the axial direction is an arc or a smooth arc chain composed of a plurality of arcs.

Preferably, the guide vane assembly is disposed adjacent to the air outlet section, the guide vane assembly includes a motor fixing seat supporting the motor and guide vanes disposed on an outer wall of the motor fixing seat, the guide vanes are connected with the inner wall of the air cylinder so as to fix the motor to the air cylinder; wherein the air cylinder, the motor fixing seat and the wheel hub are disposed coaxially.

In order to solve the above-mentioned technical problem, another technical solution adopted in the present application is:

a hair dryer having the aforementioned fan.

Compared with the prior art, the present application has the following beneficial effects:

in the fan and the hair dryer provided by the present application, the constriction area is provided at the air inlet of the fan, and the flared area is provided at the air outlet of the fan. The constriction area is configured to depressurize the airflow entering the air impeller, while the flare area is configured to diffuse the airflow flowing out of the guide vane assembly, so that the air volume of the fan can still meet the usage requirements without increasing the rotational speed, and the noise problem can be effectively solved.

In view of the deficiencies in the above technologies, the present application provides a fan and a hair dryer, which can improve the air outlet speed.

In order to solve the above-mentioned technical problem, the present application adopts the following technical solution:

a fan including: an air cylinder, an interior of the air cylinder being hollow along an axial direction of the air cylinder to form a hollow cavity extending through the air cylinder, the air cylinder having an air inlet and an air outlet; and an air outlet hood detachably disposed on the air outlet, the air outlet hood being provided with an annular air outlet for air outlet; wherein an outer ring and/or an inner ring of the annular air outlet is formed with an annular guide rib extending along a circumferential direction of the annular air outlet and extending toward the air inlet; the annular guide rib is configured to make an airflow cross section adjacent to the annular air outlet gradually decrease, so as to make an airflow in the air outlet hood cohesive, thereby increasing an air outlet speed of the annular air outlet.

Preferably, the annular guide rib disposed on the outer ring of the annular air outlet is a first annular guide rib, and the annular guide rib disposed on the inner ring of the annular air outlet is a second annular guide rib; wherein along a direction from the air inlet to the air outlet, an inner diameter of the first annular guide rib is gradually decreasing, and an outer diameter of the second annular guide rib is gradually increasing.

Preferably, an inner wall of the first annular guide rib is provided with at least a first inclined region section which forms an included angle α with an axial direction of the air outlet hood, so as to make the airflow in the air outlet hood cohesive; wherein a value range of the included angle α is: 0°≤α≤60°.

Preferably, an outer wall of the second annular guide rib is provided with at least a second inclined region section which forms an included angle β with an axial direction of the air outlet hood, so as to make the airflow in the air outlet hood cohesive; wherein a value range of the included angle β is: 0°≤α≤12°.

Preferably, the air outlet hood has an inner end surface and an outer end surface disposed opposite to the inner end surface, the annular guide rib is provided on the inner end surface, a center of the outer end surface is provided with a groove which is configured for mounting an indicator light assembly; and wherein the annular air outlet is annularly distributed on an outer circumference of the groove.

Preferably, the indicator light assembly includes a control panel and a light cover, the control panel is provided with an indicator light, the control board is disposed in the light cover and assembled with the light cover as a whole; and wherein the light cover is detachably disposed in the groove.

Preferably, an air nozzle is disposed at the air outlet, the air outlet has a first clamping structure, and the air nozzle has a second clamping structure matched with the first clamping structure; wherein after the air nozzle is clamped to the air outlet through the cooperation of the second clamping structure and the first clamping structure, the air nozzle is rotatable relative to the air cylinder.

Preferably, the first clamping structure includes a flange formed at the air outlet and a rib formed on an outer periphery of an end face of the air outlet hood; wherein the flange grows inwardly along a radial direction of the air outlet, the rib grows along the axial direction of the air outlet and abuts against the flange, and an inner ring hole diameter of the flange is smaller than an inner ring hole diameter of the rib to form a snap space; the second clamping structure includes a clamping edge formed on the air nozzle, and the clamping edge is configured to mate with the snap space.

Preferably, curved surfaces constricted inwardly are symmetrically formed on an wall surface of the air nozzle, so that the air nozzle has an air outlet with a flat mouth and an air inlet with a round mouth; the air nozzle includes an inner shell and an outer shell, the outer shell is sleeved on an outer circumference of the inner shell; wherein a connection structure is provided on a region section of a round opening of the outer shell corresponding to the curved surfaces, and the connection structure is configured for ultrasonic welding the inner shell and the outer shell.

In order to solve the above-mentioned technical problem, another technical solution adopted in the present application is:

a hair dryer having the aforementioned fan.

Compared with the prior art, the present application has the following beneficial effects:

in the fan and the hair dryer provided by the present application, the air outlet hood is based on the annular air outlet, and the annular guide rib is formed on the outer ring and/or the inner ring of the annular air outlet. As a result, the air outlet speed of the annular air outlet is effectively accelerated, the airflow is prevented from spreading at the annular air outlet, and the drying efficiency is effectively improved.

### BRIEF DESCRIPTION OF DRAWINGS

FIG. 1 is a schematic perspective structural view of a fan in an embodiment of the present application;

FIG. 2 is a schematic exploded structural view of the fan in the embodiment of the present application;

FIG. 3 is a schematic cross-sectional view of the fan in the embodiment of the present application;

FIG. 4 is a schematic view of a first inclined surface area L2 in an embodiment of the present application;

FIG. 5 is a schematic view of the first inclined surface area L2 in another embodiment of the present application;

FIG. 6 is another schematic view of the first inclined surface area L2 in another embodiment of the present application;

FIG. 7 is a schematic view of the first inclined surface area L2 in another embodiment of the present application;

FIG. 8 is an enlarged structural view of an area A in FIG. 7;

FIG. 9 is a schematic perspective structural view of an air impeller in an embodiment of the present application;

FIG. 10 is a schematic view along a front view direction of an air impeller in an embodiment of the present application;

FIG. 11 is a schematic cross-sectional view along a direction C-C in FIG. 10;

FIG. 12 is a schematic structural view of a blade in an embodiment of the present application;

FIG. 13 is a schematic structural view of a guide vane in an embodiment of the present application;

FIG. 14 is a schematic view of a blade profile of a conventional guide vane;

FIG. 15 is a schematic structural view of a hair dryer in an embodiment of the present application;

FIG. 16 is a schematic view of a connection relationship between an air cylinder and an air outlet hood in an embodiment of the present application;

FIG. 17 is a schematic structural view of the air outlet hood in an embodiment of the present application;

FIG. 18 is a schematic structural view of the air outlet hood in an embodiment of the present application;

FIG. 19 is a schematic cross-sectional view of the air outlet hood in an embodiment of the present application;

FIG. 20 is a schematic cross-sectional view of the air cylinder in an embodiment of the present application;

FIG. 21 is an enlarged structure schematic view of a region A in FIG. 1;

FIG. 22 is a schematic view of a positional relationship between the air cylinder and an air nozzle in an embodiment of the present application;

FIG. 23 is an exploded schematic view of the air cylinder and the air nozzle in an embodiment of the present application;

FIG. 24 is a schematic structural view of an indicator light assembly in an embodiment of the present application;

FIG. 25 is a schematic structural view of the air nozzle in an embodiment of the present application;

FIG. 26 is a schematic exploded structural view of the air nozzle in an embodiment of the present application;

FIG. 27 is an enlarged schematic view of a region B in FIG. 11; and

FIG. 28 is a schematic view along a front view of a round opening of the outer shell in an embodiment of the present application.

### DETAILED DESCRIPTION

The present application will be further described in detail below with reference to the accompanying drawings, so that those skilled in the art can implement it with reference to the description. If there are descriptions involving “first”, “second”, etc., in the embodiments of the present application, the description of “first”, “second”, etc., are only used for the purpose of description, and should not be understood as indicating or implying their relative importance or implying the number of technical features indicated. Thus, a feature delimited with “first”, “second” may expressly or implicitly include at least one of that feature.

In the description of the present application, it should also be noted that, unless there are more explicit definitions and limitations, the terms “disposed” and “connected” should be understood in a broader sense. For example, the term “connected” may be a fixed connection, a detachable connection, or an integral connection; a mechanical connection or an electrical connection; a direct connection, or an indirect connection through an intermediate medium, or a communication of two elements. For those of ordinary skill in the art, the specific meanings of the above terms in the present disclosure can be understood in specific situations.

In addition, if the meaning of “and/or” appears in the present application, it includes three concurrent solutions. Taking “A and/or B” as an example, it includes a solution A, or a solution B, or a solution that satisfies both the solution A and the solution B. In addition, the technical solutions between the various embodiments can be combined with each other, but must be based on the realization by those of ordinary skill in the art. When a combination of technical solutions contradicts each other or cannot be realized, it shall be considered that such combination of technical solutions does not exist, and is not within the protection scope claimed in the present application.

Existing hair dryers are developing in a direction of small diameter and short body. This will inevitably require the diameter of the entire fan to be reduced accordingly, so that when the air volume of the fan needs to be guaranteed, the speed of the fan must be increased, which will lead to increased noise and affect the user's experience.

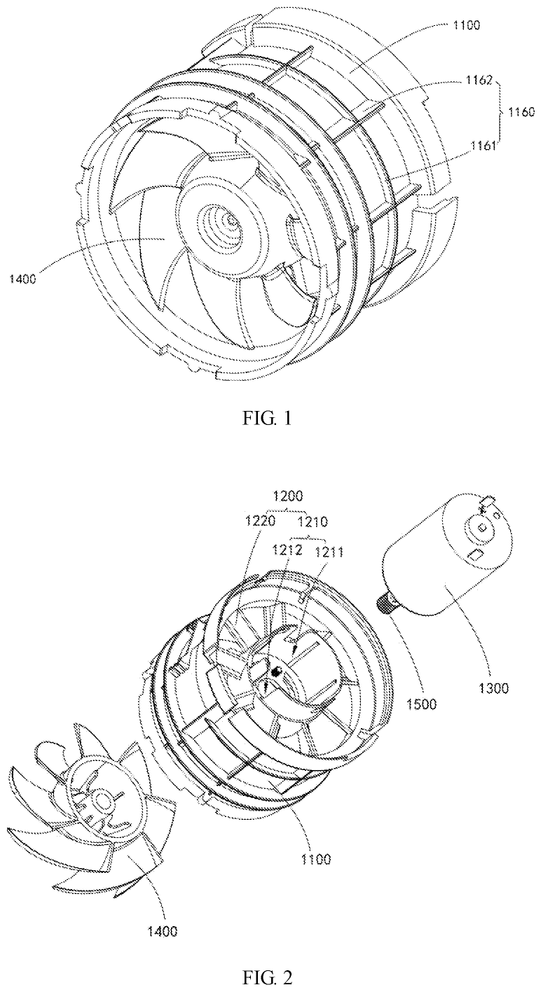

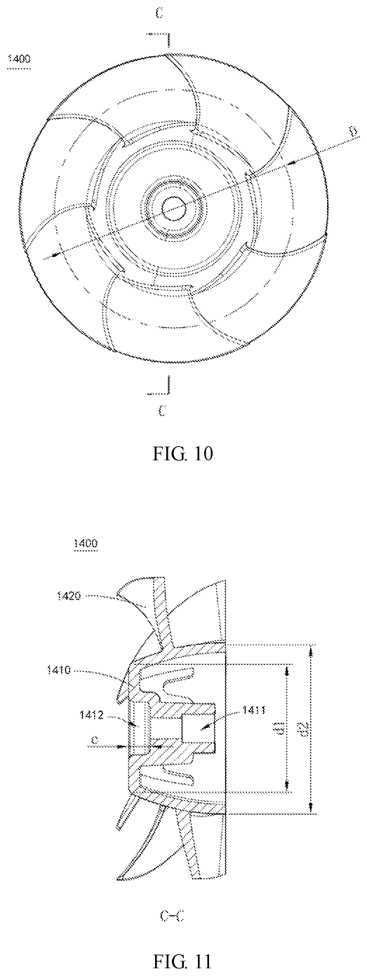

In view of this, as shown in FIG. 1 to FIG. 15, embodiments of the present application provide a fan and a hair dryer with good air outlet performance.

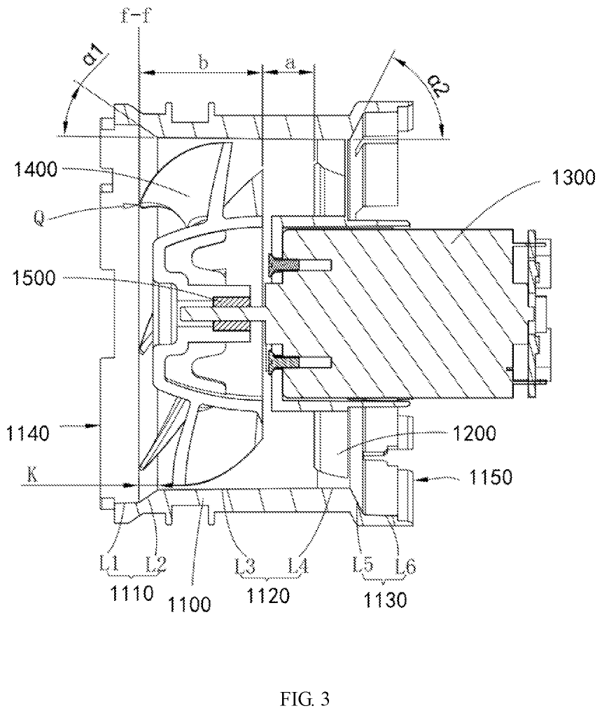

Referring to FIG. 1 to FIG. 3, in which FIG. 1 is a schematic structural view of a fan in the present application, FIG. 2 is a schematic exploded structural view of the fan in the present application, and FIG. 3 is a schematic cross-sectional view of the fan in an embodiment of the present application, the fan includes an air cylinder 1100, an air impeller 1400 and a guide vane assembly 1200. An interior of the air cylinder 1100 is hollow along its axial direction so as to form a hollow cavity extending through the air cylinder 1100. The air cylinder 1100 has an air inlet 1140 and an air outlet 1150. The air impeller 1400 is disposed inside the air cylinder 1100 for blowing the air cylinder 1100 to form a high-speed airflow. The guide vane assembly 1200 is disposed inside the air cylinder 1100 and is disposed adjacent to the air impeller 1400. The guide vane assembly 1200 is used to rectify an airflow entering the air cylinder 1100. Wherein, along an air inlet direction from the air inlet 1140 to the air outlet 1150, an inner wall of the air cylinder 1100 includes an air inlet section 1110, a socket section 1120 and an air outlet section 1130 which are connected in sequence. The air impeller 1400 and the guide vane assembly 1200 are provided on the socket section 1120. The air inlet section 1110 is provided with a constriction area. The constriction area extends to form the air inlet 1140, and the constriction area is configured to depressurize the airflow entering the air impeller 1400. The air outlet section 1130 is provided with a flared area. The flared area extends to form the air outlet 1150, and the flared area is configured to diffuse the airflow flowing out of the guide vane assembly 1200. The air impeller 1400 is disposed adjacent to the air inlet section 1110, and the guide vane assembly 1200 is disposed adjacent to the air outlet section 1130.

In the above-mentioned manner, the constriction area in the present application is configured to depressurize the airflow entering the air impeller 1400, and the flared area is configured to diffuse the airflow flowing out of the guide vane assembly 1200, so that the fan can still meet the demand for air volume without increasing the rotational speed of the fan, and effectively solve the noise problem.

Besides, continue to refer to FIG. 3, the air inlet section 1110 includes a first flat straight area L1 and a first inclined surface area L2. The first inclined surface area L2 is farther from the air inlet 1140 than the first flat straight area L1. The first flat straight area L1 is substantially parallel to the axial direction of the air cylinder 1100. Two ends of the first inclined surface area L2 are connected with the first flat straight area L1 and the socket section 1120, respectively. In addition, the first inclined surface area L2 and the axial direction of the air cylinder 1100 are disposed at a first included angle α1 to form the constriction area. Therefore, when the fan works, the airflow firstly passes through the first flat straight area L1 for rectification and then passes through the first inclined surface area L2 for airflow acceleration, so that the airflow pressure at the air inlet 1140 of the air cylinder along the air inlet direction is gradually reduced, and the airflow can enter the air impeller 1400 at a lower pressure. By designing the air inlet 1140 as described above, the air pressure at the air inlet 1140 can be reduced, thereby preventing the airflow in the air cylinder 1100 from flowing back.

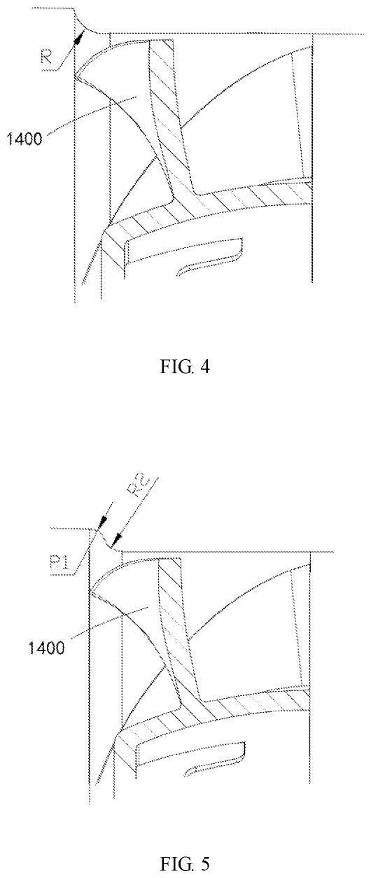

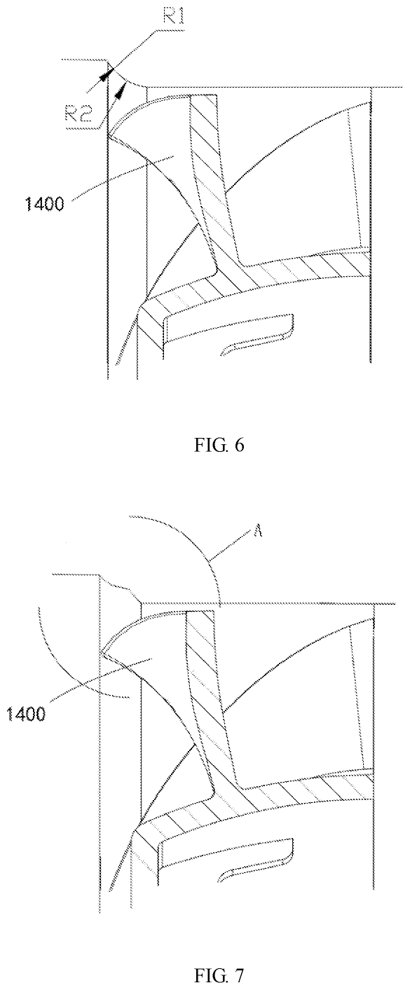

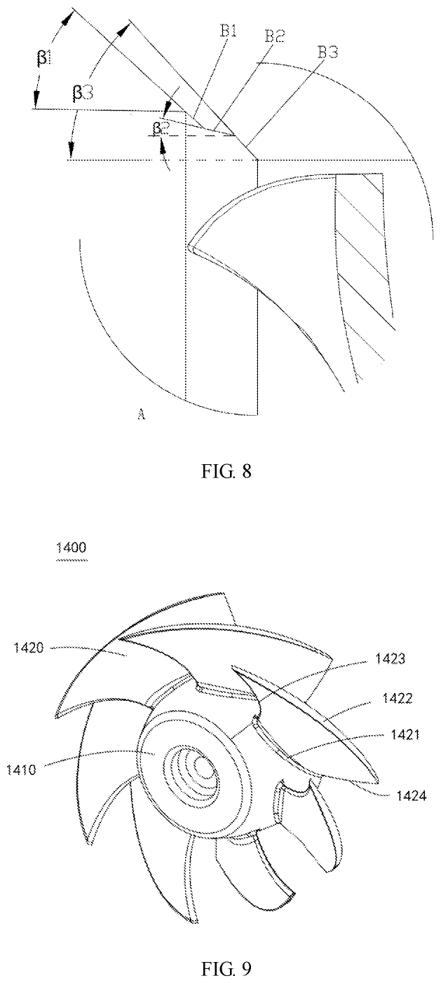

Specifically, the constriction area corresponds to the first inclined surface area L2. There are many ways to realize the constriction area. Referring to FIG. 4 to FIG. 6, the constriction area can be an arc or an arc chain formed by smooth connection of a plurality of arcs. Referring to FIG. 7 and FIG. 8, the necking area may be a polyline formed by a straight line or a plurality of straight lines. FIG. 4 is a schematic view when the first inclined surface area L2 is a single circular arc R. FIG. 5 and FIG. 6 are schematic views showing that the first inclined surface area L2 is formed by the smooth connection of two arcs with radii R1 and R2, respectively. Of course, the first inclined surface area L2 may also be formed by smooth connection of a plurality of arcs with different radii. FIG. 3 is a schematic view showing that the first slope area L2 is formed by a straight line. A first included angle α1 is formed by the straight line and the axial direction of the air cylinder 100. A value range of the first included angle α 1 is: 30°≤α1≤60°. FIG. 7 and FIG. 8 are broken lines formed by three straight line segments in the first inclined surface area L2. In the air inlet direction from the air inlet 140 to the air outlet 1150, the first inclined surface area L2 sequentially includes a first straight line segment B1 which forms an included angle β1 with the axial direction of the air cylinder 1100, a second straight line segment B2 which forms an included angle β2 with the axial direction of the air cylinder 1100, and a third straight line segment B3 which forms an included angle β3 with the axial direction of the air cylinder 1100. Of course, the first inclined surface area L2 may also be a broken line composed of a plurality of straight line segments. The present application is not limited to this, and may also be a combination of an arc and a straight line, which is not further limited here.

Furthermore, the socket section 1120 includes a second flat straight area L3 and a third flat straight area L4 which are substantially parallel to the axial direction of the air cylinder 11100. The second flat straight area L3 is connected with the first inclined surface area L2 and the third flat straight area L4, respectively. The second flat straight area L3 is farther from the air outlet section 1130 than the third flat straight area L4. A diameter of the second flat straight area L3 is smaller than a diameter of the first flat straight area L1. The air impeller 1400 is mounted in the second flat straight area L3. The guide vane assembly 1200 is installed in the third flat straight area L4.

Furthermore, referring to FIG. 3, the air outlet section 1130 includes a second inclined surface area L5 and a fourth flat straight area L6. The fourth flat straight area L6 is substantially parallel to the axial direction of the air cylinder 1100. The second inclined surface area L5 is connected with the third flat straight area L4 and the fourth flat straight area L6, respectively. In addition, the second inclined surface area L5 and the axial direction of the air cylinder 1100 are disposed at a second included angle α2 to form a flared area. The second inclined surface area L5 is farther from the air outlet 1150 than the fourth flat straight area L6. A diameter of the fourth flat straight area L6 is larger than a diameter of the third flat straight area L4. Therefore, the airflow can be diffused in the air outlet section 1130, so that the kinetic energy is converted into static pressure, the pressure resistance of the fan is improved, and the exhaust loss is reduced.

Furthermore, referring to FIG. 3 in conjunction with FIG. 9, the air impeller 1400 is fastened on an output shaft of a motor 1300. The air impeller is completely nested in the air cylinder 1100, and can rotate around the output shaft of the motor 1300 in the air cylinder 1100. The air impeller 1400 includes a wheel hub 1410 connected with the output shaft of the motor 1300 and blades 1420 arranged on an outer wall of the wheel hub 1410 at equal intervals along a circumferential direction of the wheel hub 1410. The wheel hub 1410 is installed in the second flat straight area L3. The blades 1420 are located in the first inclined surface area L2 and the second flat straight area L3. The blade 1420 has a blade root 1421 connected to the wheel hub 1410, a blade tip 1422 disposed away from the blade root 1421, a blade leading edge 1423 as a windward side and a blade trailing edge 1424 as a downwind side. The blade leading edge 1423 and the blade trailing edge 1424 are located on both sides of the blade root 1421 and the blade tip 1422, respectively. In the second flat straight area L3, a gap between the blade tip 1422 and the inner wall of the air cylinder 1100 gradually decreases along the air inlet direction. In this way, a backflow of a top clearance of the blade 420 can be effectively prevented, thereby improving the efficiency of the fan.

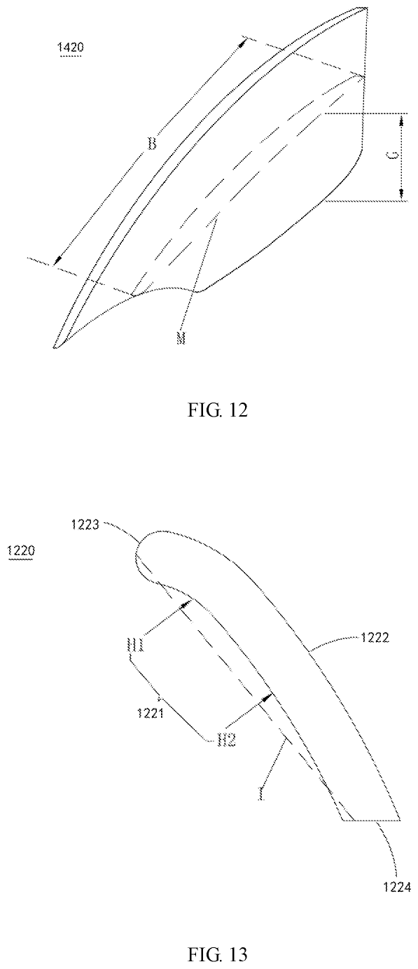

Specifically, referring to FIG. 12, the blade 1420 is configured such that a section M in the circumferential direction of the wheel hub 1410 is arc-shaped, and a chord length B corresponding to the section M increases as the radius of the blade 1420 increases. That is, a cross-sectional shape of the blade 1420 in the circumferential direction of the wheel hub 1410 continuously changes according to the size of the radius of the blade 1420. The plurality of blades 1420 are arranged in a twisted attitude on the outer wall of the wheel hub 1410, and the blade leading edge and the blade trailing edge of adjacent two blades 1420 overlap.

Specifically, referring to FIG. 9 to FIG. 12, a height of the blade 1420 is defined as a distance from the blade tip 1422 of the blade 1420 to the blade root 1421. If a diameter at a certain height G of the blade 1420 is D, the following relationship is satisfied among the number n1 of blades 1420, the chord length B at the blade height, and the diameter D of the blade 1420: 0.35<(B*n1/D)<0.48, where the number n1 of blades 1420 satisfies 5≤n1≤13. Based on this, after the blade 1420 meets the above design, the chord length B gradually increases from the blade root 1421 to the blade tip 1422, and the working power of the air impeller 1400 is enhanced under the same rotation speed. In addition, the installation angle of the blade 1420 from the blade root 1421 to the blade tip 1422 is less twisted, and the blade 1420 has high strength.

Referring to FIG. 3 in conjunction with FIG. 9, considering the existence of assembly errors, after the air impeller 1400, the guide vane assembly 1200 and the motor 1300 are all installed on the air cylinder 1100, an axial distance between an interface f-f of the first flat straight area L1 and the first inclined surface area L2 and a leading edge point Q of the blade 1420 is less than 0.05*K; wherein the interface f-f is perpendicular to an axis of the air cylinder 1100, the leading edge point Q of the blade 1420 is where the blade tip 1422 meets the blade leading edge 1423, and K is a length of the first inclined surface area L2 in the axial direction of the air cylinder 1100. The best assembled state of the air impeller 1400 is that the leading edge point Q of the blade 1420 is located on the interface f-f. That is, the axial distance between the interface f-f and the leading edge point Q of the blade 1420 is zero.

Furthermore, referring to FIG. 3 in conjunction with FIG. 11, an outer diameter of the wheel hub 1410 is gradually increasing in the air inlet direction. A diameter d1 of a small end face of the wheel hub 1410 adjacent to the air inlet 1140 is smaller than a diameter d2 of a large end face of the wheel hub 1410 away from the air inlet 1150. Specifically, a projection of an outer peripheral surface of the wheel hub 1410 in the axial direction is an arc or a smooth arc chain composed of a plurality of arcs. That is, the outer peripheral surface of the wheel hub 1410 is formed by splicing one or more arc surfaces in its axial direction. When the projection of the outer peripheral surface of the wheel hub 1410 in the axial direction is a smooth arc chain composed of a plurality of arcs, the number of arc segments is n2, which satisfies n2 and the radius of each arc is different. Therefore, when the airflow enters the air cylinder 100 through the blades 1420, the airflow can move along the outer wall of the wheel hub 1410 to the guide vane assembly 1200, thereby avoiding a phenomenon of intake air backflow and airflow separation at the blade root 1421.

Furthermore, continue to refer to FIG. 3 in conjunction with FIG. 11, the wheel hub 1410 of the air impeller 1400 can be connected to the output shaft of the motor 1300 through a knurled nut 1500. Specifically, an interference connection is adopted between the knurled nut 1500 and the output shaft of the motor 1300. The wheel hub 1410 is provided with a mounting hole 1411 which is matched with the knurled nut 1500. The knurled nut 1500 is press-fitted into the mounting hole 1411. In order to facilitate press-fitting the knurled nut 1500 into the mounting hole 1411, a groove 1412 is provided on the small end face of a front end of the wheel hub 1410. The groove 1412 communicates with the mounting hole 1411. A groove depth of the groove 1412 is c, and a value range of the groove depth c is: (d1/3)≤c≤(d1/2). An outer circumference of the knurled nut 1500 is provided with knurling, thereby increasing the bonding strength with the wheel hub 1410, reducing the jitter between the air impeller 1400 and the output shaft of the motor 1300 when rotating, and reducing noise.

Furthermore, referring to FIG. 2 in conjunction with FIG. 3, the guide vane assembly 1200 includes a motor fixing seat 1210 supporting the motor 1300 and a plurality of guide vanes 1220 disposed on an outer wall of the motor fixing seat 1210. The guide vanes 1220 are connected to the motor fixing seat 1210 and the inner wall of the air cylinder 1100 in the third flat straight area L4, respectively, to fix the motor 1300 to the air cylinder 1100. The number of guide vanes 1220 is n3, which satisfies 5≤n3≤13. On the one hand, the guide vanes 1220 fix the motor 1300 in the air cylinder 1100, and on the other hand, the guide vanes 1220 play a guiding role in the airflow in the air impeller 1400, so as to homogenize the airflow. The motor fixing seat 1210 has an accommodating groove 1211 for installing the motor 1300 and a through hole 1212 formed on a groove wall of the accommodating groove 1211 for passing the output shaft of the motor 1300 to a side of the air impeller 1400. The output shaft of the motor 1300 is connected to the air impeller 1400 after passing through the above-mentioned through hole 1212, so that when the motor 1300 rotates, the air impeller 1400 is driven to rotate. The air cylinder 1100, the motor fixing seat 1210 and the wheel hub 1410 are arranged coaxially.

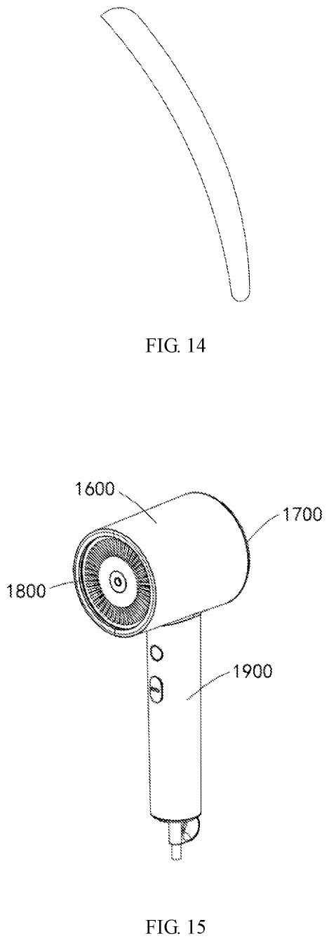

Furthermore, in order to reduce the dynamic and static interference effect between the air impeller 1400 and the guide vane 1220, the blade shape of the guide vane 1220 is designed. Referring to FIG. 13, which is a schematic view of the blade profile of the guide vane 1220. The blade profile of the guide vane 1220 includes a pressure surface profile 1221, a trailing edge profile 1224 as a downwind side, a suction surface profile 1222, and a leading edge profile 1223 as a windward side. The pressure surface profile 1221, the trailing edge profile 1224, the suction surface profile 1222 and the leading edge profile 1223 are connected end to end. The leading edge profile 1223 is a single arc, which is smoothly connected with a starting point of the pressure surface profile 1221 and a starting point of the suction surface profile 1222. The trailing edge profile 1224 connects a tail end of the pressure surface profile 1221 and a tail end of the suction surface profile 1222. The suction surface profile 1222 adopts a single arc design. The pressure surface profile 1221 is designed with two arcs, in which a 1/4 to 1/3 section from the leading edge of the guide vane 1220 to the chord length I of the blade adopts a profile arc H1, and the profile arc H1 is smoothly linked with its subsequent profile arc H2. Please continue to refer to FIG. 14, which is a schematic view of a blade profile of a conventional guide vane profile. Compared with the conventional guide vane shape, the pressure surface profile 1221 of the present application is designed with two circular arcs, which can form a concave portion on a pressure front edge adjacent to the leading edge profile 1223, thereby effectively reducing the static and dynamic interference effect between the air impeller 1400 and the guide vane 1220.

Specifically, after the air impeller 1400, the guide vane assembly 1200 and the motor 1300 are all installed to the air cylinder 1100, considering the existence of assembly errors, a distance between the blade trailing edge 1424 of the air impeller 1400 and the blade leading edge in the axial direction of the air cylinder 1100 is defined as a distance a, a length of the fan wheel 1400 in the axial direction of the air cylinder 1100 is defined as a distance b, and the distance a and the distance b satisfy the relationship, 0.15b≤a≤0.45b, wherein the blade leading edge refers to a position where the leading edge profile 1223 is located.

Furthermore, in consideration of the stability of the fan during operation, a reinforcing rib 1160 is provided on the outer wall of the air cylinder 1100. Referring to FIG. 1, the reinforcing rib 1160 includes a transverse rib 1162 parallel to the airflow direction of the air cylinder 1100 and an annular rib 1161 perpendicular to the airflow direction of the air cylinder 1100. In this way, the stability and reliability of the connection between the air cylinder 1100 and an outer cylinder 1600 can be improved, thereby improving the stability of the fan during operation.

It can be understood that the fan in the present application can be applied to different usage scenarios, which will be described below with examples.

The fan in the present embodiments can be applied to a hair dryer. Referring to FIG. 15, the hair dryer includes an outer cylinder 1600, the fan provided inside the outer cylinder 1600, and a handle 1900 located outside the outer cylinder 1600. The outer cylinder 1600 is hollow inside and provided with openings at both ends. The fan is located in a hollow cavity of the outer cylinder 1600. An air inlet hood 1700 and an air outlet hood 1800 are provided at the openings at both ends of the outer cylinder 1600, respectively. The air inlet hood 1700 is arranged adjacent to the fan. The handle 1900 is connected with the outer cylinder 1600 and is located below the outer cylinder 1600 to support the outer cylinder 1600.

It can be understood that the above specific applications are only examples of the fans in the present application. Those skilled in the art can make adaptive adjustments according to the actual situation, which will not be repeated here.

In summary, in the present application, the air inlet section 1110 is divided into the first flat straight area L1 and the first inclined surface area L2, when the airflow enters the fan from the outside, it is rectified through the first flat straight area L1, and accelerated and depressurized in the first inclined surface area L2, so that the airflow pressure along the air inlet direction is gradually reduced, and the airflow enters the air impeller 1400 at a lower pressure. Therefore, it can effectively prevent a pressure P2 at an inlet of the air impeller 1400 being greater than a pressure P1 at the air inlet 1140 due to the forced work and pressurization after the airflow enters the air impeller 1400, thereby preventing the airflow from forming backflow, and avoiding the loss of air volume and efficiency. In the present application, the air outlet section 1130 is divided into the second inclined surface area L5 and the fourth flat straight area L6. Therefore, the airflow can be diffused in the air outlet section 1130, so that the kinetic energy is converted into static pressure, the pressure resistance of the fan is improved, and the exhaust loss is reduced.

A hair dryer dries wet hair by generating wind with a specific temperature. Drying efficiency is a main indicator for measuring the performance of the hair dryer. After the hair dryer is powered on, a motor drives an impeller to rotate, and the air is sucked in from the air inlet. The sucked air is heated by an electric heating element to form hot air and then blown out from the air outlet. At present, an annular air outlet of the air outlet hood on the market does not have a gathering effect on the air outlet, and the air outlet is easy to diffuse, which makes the air outlet speed slower, thereby affecting the drying efficiency.

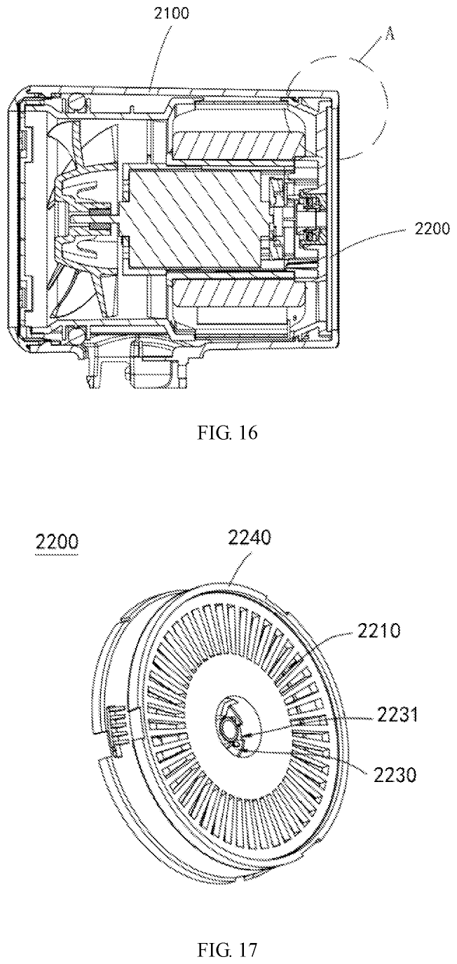

In view of this, as shown in FIG. 16 to FIG. 28, the present application provides a fan and a hair dryer with a faster air outlet speed.

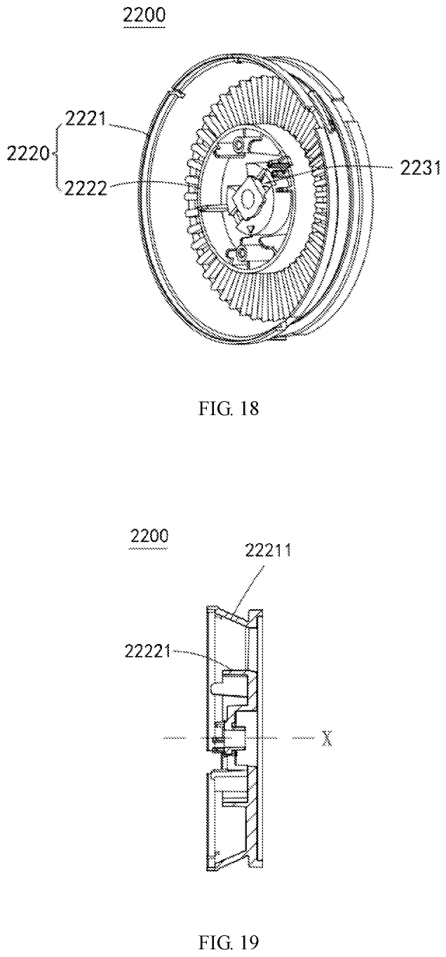

Referring to FIG. 16 to FIG. 20, in which FIG. 16 is a schematic view of the connection relationship between the air cylinder 2100 and the air outlet hood 2200 in the present application, FIG. 17 is a schematic structural view of the air outlet hood 2200 in the present application, FIG. 18 and FIG. 19 are schematic views of the air outlet hood 2200 according to an embodiment of the present application, the fan includes an air cylinder 2100 and an air outlet hood 2200. An interior of the air cylinder 2100 is hollow along its axial direction to form a hollow cavity extending through the air cylinder 2100. The air cylinder 2100 has an air inlet 2110 and an air outlet 2120. The air outlet hood 2200 is detachably disposed on the air outlet 2120. The air outlet hood 2200 is provided with an annular air outlet 2210 for air outlet. An outer ring and/or an inner ring of the annular air outlet 2210 is formed with a plurality of annular guide ribs 2220 extending along a circumferential direction of the annular air outlet 2210 and toward the air inlet 2110. The annular guide ribs 2220 are configured to gradually reduce the airflow cross section near the annular air outlet 2210, so that the airflow in the air outlet hood 2200 is cohesive, thereby increasing the air outlet speed of the annular air outlet 2210.

In the above manner, the annular air outlet 2210 of the air outlet hood 2200 in the present application is provided with the annular guide ribs 2220 which can make the airflow cohesive, so as to speed up the air outlet speed of the annular air outlet 2210 and prevent the airflow from spreading at the annular air outlet 2210, thereby effectively improving the drying efficiency.

Furthermore, the annular air outlet 2210 in the present application is provided with a number of air distribution ribs distributed along a radial direction of the annular air outlet 2210. The air distribution ribs are distributed on the annular air outlet 2210 in a circular array. Understandably, the annular guide ribs 2220 formed on the outer ring and/or the inner ring of the annular air outlet 1210, includes three parallel situations: first, the annular guide ribs 2220 are only provided on the outer ring of the annular air outlet 2210; second, the annular guide ribs 2220 are only provided on the inner ring of the annular air outlet 2210; and third, the annular guide ribs 2220 are provided on the outer ring and the inner ring of the annular air outlet 2210 at the same time. Preferably, the annular guide ribs 2220 are arranged on the outer ring and the inner ring of the annular air outlet 2210 at the same time. Referring to FIG. 18 and FIG. 19, in this arrangement, the airflow in the air outlet hood 2200 can be more easily cohesive, and the cohesion effect is good.

Specifically, the annular guide ribs 2220 are divided into a first annular guide rib 2221 and a second annular guide rib 2222 according to different installation positions. Referring to FIG. 18 and FIG. 19, the annular guide rib 2220 disposed on the outer ring of the annular air outlet 2210 is the first annular guide rib 2221, and the annular guide rib 2220 disposed on the inner ring of the annular air outlet 2210 is the second annular guide rib 2222. Both the first annular guide rib 2221 and the second annular guide rib 2222 are formed by a 360° rotation around a central axis X of the air outlet hood 2200. Along the direction from the air inlet 2110 to the air outlet 2120, an inner diameter of the first annular guide rib 2221 is gradually decreasing, and an outer diameter of the second annular guide rib 2222 is gradually increasing.

Furthermore, an inner wall of the first annular guide rib 2221 is provided with at least a first inclined region section 22211 which forms an angle α with an axial direction of the air outlet hood 2200, so that the airflow in the air outlet hood 2200 is cohesive. An outer wall of the second annular guide rib 2222 is provided with at least a second inclined region section 22221 which forms an angle β with the axial direction of the air outlet hood 2200, so that the airflow in the air outlet hood 2200 is cohesive. Wherein a value range of the included angle α is: 0°≤α≤60°. A value range of the included angle β is: 0°≤α≤12°. Specifically, a projection of the first inclined region section 22211 and the second inclined region section 22221 on a vertical plane passing through the central axis X of the air outlet hood 2200 may be a straight line segment or an arc segment. The included angle between the arc segment and the axial direction of the air outlet hood 2200 is defined as the included angle between a line connecting a starting point and an ending point of the arc segment and the central axis X.

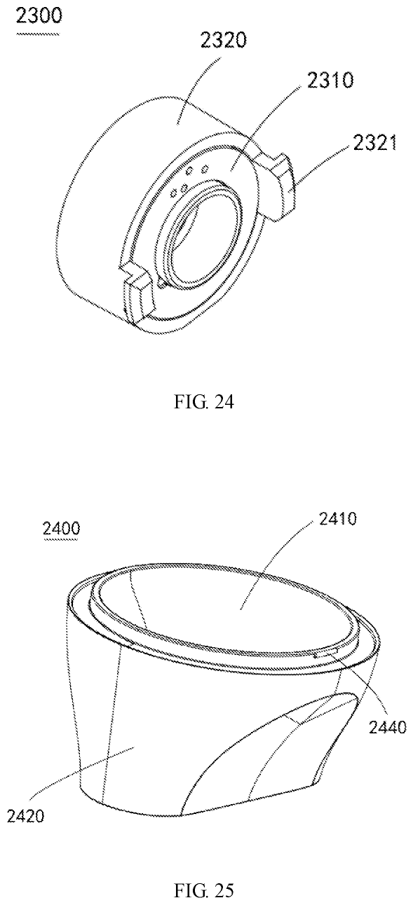

Furthermore, an indicator light assembly 2300 is also provided on the fan. The indicator light assembly 2300 is used to display whether a negative ion generator is in a working state or not. Referring to FIG. 24, the indicator light assembly 2300 includes a control board 2310 provided with an indicator light, and a light cover 2320. The control board 2310 is disposed in the light cover 2320 and assembled with the light cover 2320 as a whole. The light cover 2320 is made of light-transmitting material. When the control panel 2310 is powered on, the indicator light illuminates the light cover 2320, which can have a lighting effect showing the shape of the light cover 2320. The shape of the light cover 2320 may be a ring, an elliptical ring, a circle, an ellipse or other shapes, which are not further limited herein.

Specifically, in order to make the light display position of the indicator light assembly 2300 more obvious and the installation more convenient, the indicator light assembly 2300 is installed on the air outlet hood 2200. Referring to FIG. 17 and FIG. 18 in conjunction with FIG. 23, the air outlet hood 2200 has an inner end surface and an outer end surface disposed opposite to each other. The annular guide ribs 2220 are provided on the inner end surface. A groove 2230 is provided in a center of the outer end surface. The annular air outlet 2210 is annularly distributed on an outer circumference of the groove 2230. The groove 2230 is configured for installing the indicator light assembly 2300, so that the indicator light can be displayed on a front face of the air cylinder 2100 adjacent to the user, and the position is obvious and the lighting effect is better. The shape and size of the groove 2230 matches the shape and size of the indicator light assembly 2300. The indicator light assembly 2300 and the groove 2230 are connected in a detachable manner. It can be understood that the indicator light assembly 2300 and the groove 2230 can be connected by a snap structure, or can be connected by a screw. In order to facilitate installation, in the present application, the indicator light assembly 1300 and the groove 1230 are connected by the snap structure. The snap structure includes a buckle 2321 arranged on the light cover 2320 and a snap hole 2231 arranged in the groove 2230 and matched with the buckle 2321.

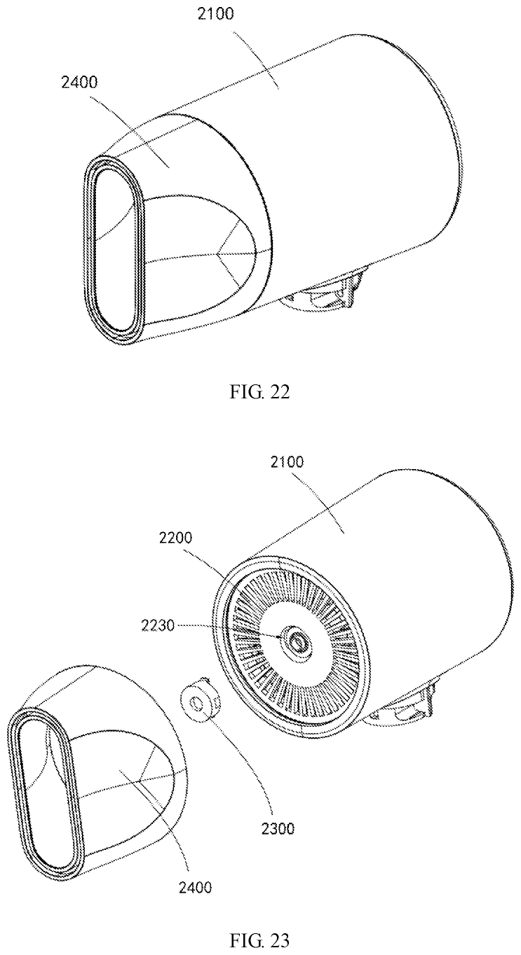

Furthermore, referring to FIG. 22 and FIG. 23, the fan is also provided with an air nozzle 2400. The air nozzle 2400 is arranged at the air outlet 2120 for constraining the wind pattern. In order to make the installation of the air nozzle 2400 and the air cylinder 2100 more convenient, the air nozzle 2400 and the air cylinder 2100 are connected by a clamping connection. The air outlet 2120 has a first clamping structure. The air nozzle 2400 has a second clamping structure matched with the first clamping structure. After the air nozzle 2400 is clamped to the air outlet 2120 through the cooperation between the second clamping structure and the first clamping structure, the air nozzle 2400 can rotate 360° relative to the air cylinder 2100. When the air nozzle 2400 needs to be disassembled from the air cylinder 2100, the disassembly can be realized only by exerting a certain axial pulling force on the air nozzle 2400.

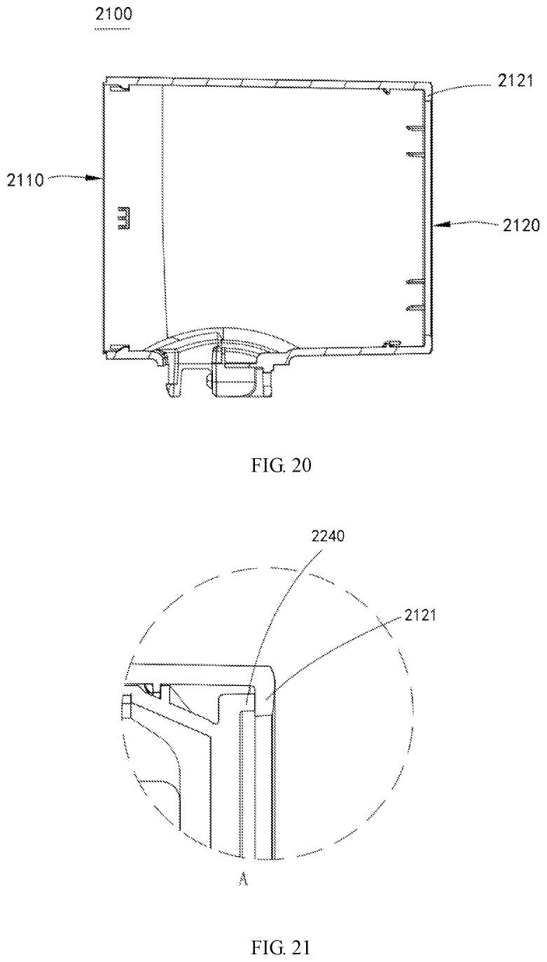

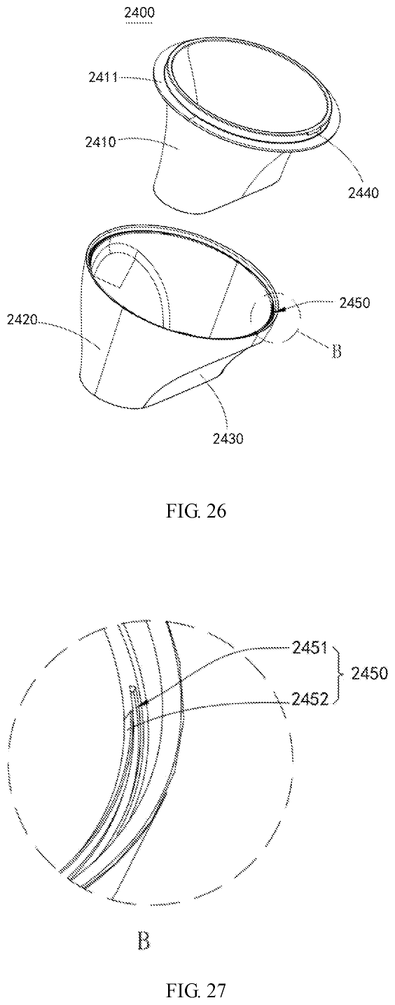

Specifically, referring to FIG. 20 and FIG. 21, the first clamping structure includes a flange 2121 formed at the air outlet 2120 and a rib 2240 formed on an outer periphery of the end surface of the air outlet hood 2200. The flange 2121 grows inwardly along a radial direction of the air outlet 2120. The rib 2240 grows along the axial direction of the air outlet 2120 and abuts against the flange 2121. An inner diameter of the flange 2121 is smaller than an inner diameter of the rib 2240 so as to form a snap space. Referring to FIG. 25 and FIG. 26, the second clamping structure includes a clamping edge 2440 formed on the air nozzle 2400. The clamping edge 2440 is configured to mate with the snap space. Curved surfaces 2430 constricted inwardly are symmetrically arranged on the wall surface of the air nozzle 2400, so that the air nozzle 2400 has a flat air outlet and a round air inlet. The clamping edge 2440 is disposed at an edge of the air inlet of the air nozzle 2400.

Furthermore, considering the anti-scalding and wind-gathering effects, the air nozzle 2400 is designed as a double-layer structure. The air nozzle 2400 includes an inner shell 2410 and an outer shell 2420. The outer shell 2420 is sleeved on an outer circumference of the inner shell 2410. Shapes of the inner shell 2410 and the outer shell 2420 are similar, and both have a flat air outlet and a round air inlet. The clamping edge 2440 can be located at the air inlet of the outer shell 2420 or at the air inlet of the inner shell 2410. In the present application, the clamping edge 2440 is a pair of arc-shaped convex edges which are symmetrically disposed at the air inlet of the inner shell 2410.

Furthermore, in order to make the inner shell 2410 and the outer shell 2420 have better connection reliability and stability, the inner shell 2410 and the outer shell 2420 need to be fixedly connected by arranging a connection structure 2450. Considering the appearance effect after the inner shell 2410 and the outer shell 2420 are connected and matched, ultrasonic welding is adopted between the inner shell 2410 and the outer shell 2420. Accordingly, the above-described connection structure 2450 is configured for ultrasonic welding of the inner shell 2410 and the outer shell 2420.

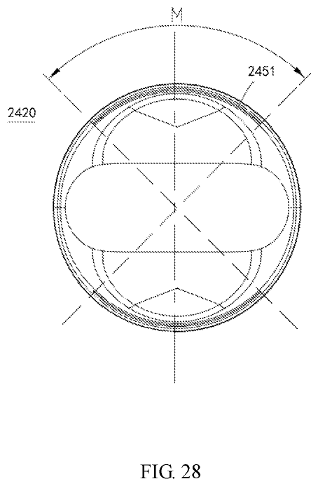

Specifically, the connection structure 2450 is located on an area segment of the round opening of the outer shell 2420 corresponding to the curved surface 2430. Referring to FIG. 27, the connection structure 2450 includes a welding groove 2451 and a welding rib 2452 formed on the round opening of the outer shell 2420. The welding groove 2451 and the welding rib 2452 are arranged adjacent to each other. Referring to FIG. 28, the welding groove 2451 is disposed on the round opening of the outer shell 2420 in a center-symmetrical manner. A central angle corresponding to the area where the welding groove 2451 is located is M, and the central angle M is 80°. The welding rib 2452 is disposed within the area where the welding groove 2451 is located. The welding rib 2452 may be continuous in a single segment, or may be arranged in multiple segments uniformly or non-uniformly within this range. An outer wall of the inner shell 2410 adjacent to the round opening is provided with an annular welding edge 2411 growing along its radial direction. The welding edge 2411 is used to mate with the connection structure 2450 to realize the fixed connection between the inner shell 2410 and the outer shell 2420.

It can be understood that the fan in the present application can be applied to different usage scenarios, which will be described below with examples.

The fan in the present application can be applied to a hair dryer. The hair dryer includes the fan and a handle connected with the fan. The handle is located below the fan for supporting the fan. The handle has a built-in negative ion generator. An inside of the fan is provided with an emitting needle electrically connected with the negative ion generator. The emitting needle is connected with the negative ion generator through a wire. When the negative ion generator is activated, the indicator light of the indicator light assembly 2300 emits bright light, which can display the lighting effect in the shape of the light cover 2320.

It can be understood that the above specific applications are only examples of the fan in the present application. Those skilled in the art can make adaptive adjustments according to the actual situation, which will not be repeated here.

In summary, the air outlet hood in the present application is based on the annular air outlet, and annular guide ribs are formed on the outer ring and/or the inner ring of the annular air outlet, thereby effectively speeding up the air outlet speed of the annular air outlet. It avoids the airflow from spreading at the annular air outlet, and effectively improves the drying efficiency. The control board of the indicator light assembly is assembled with the light cover as a whole, and is arranged on the air outlet hood through the light cover. The indicator light can be displayed on the front face of the air cylinder adjacent to the user, the installation is convenient, the position is obvious, and the lighting effect is better. The air nozzle and the air cylinder are connected by the snap connection, which has the advantage of convenient installation. The air nozzle is designed with the double-layer structure, which can effectively improve the anti-scalding and wind-gathering effects.

1: A fan, comprising:
an air cylinder, an interior of the air cylinder being hollow along an axial direction of the air cylinder to form a hollow cavity which extends through the air cylinder, the air cylinder having an air inlet and an air outlet;
an air impeller, disposed inside the air cylinder and is configured for blowing the air cylinder to form a high-speed airflow; and
a guide vane assembly, disposed inside the air cylinder and adjacent to the air impeller, the guide vane assembly being configured to rectify an airflow entering the air cylinder;
wherein along an air inlet direction from the air inlet to the air outlet, an inner wall of the air cylinder comprises an air inlet section, a socket section and an air outlet section which are connected in sequence; and the air impeller and the guide vane assembly are disposed on the socket section;
the air inlet section is provided with a constriction area, the constriction area extends to form the air inlet, and the constriction area is configured to depressurize the airflow entering the air impeller; the air outlet section is provided with a flared area, the flared area extends to form the air outlet, and the flared area is configured to diffuse the airflow out of the guide vane assembly.

2: The fan according to claim 1, wherein the air inlet section comprises:
a first flat straight area substantially parallel to the axial direction of the air cylinder; and
a first inclined surface area connected with the first flat straight area and the socket section, respectively; and the first inclined surface area and the axial direction of the air cylinder are disposed at a first included angle to form the constriction area;
wherein the first inclined surface area is farther from the air inlet than the first flat straight area.

3: The fan according to claim 2, wherein:
the socket section comprises a second flat straight area and a third flat straight area which are substantially parallel to the axial direction of the air cylinder; the second flat straight area is connected with the first inclined surface area and the third flat straight area, respectively;
wherein the second flat straight area is farther from the air outlet section than the third flat straight area, a diameter of the second flat straight area is smaller than a diameter of the first flat straight area, the air impeller is mounted on the second flat straight area, and the guide vane assembly is mounted on the third flat straight area.

4: The fan according to claim 3, wherein the air outlet section comprises:
a fourth flat straight area substantially parallel to the axial direction of the air cylinder; and
a second inclined surface area connected with the third flat straight area and the fourth flat straight area, respectively; the second inclined surface area and the axial direction of the air cylinder are disposed at a second included angle to form the flared area;
wherein the second inclined surface area is farther from the air outlet than the fourth flat straight area, and a diameter of the fourth flat straight area is larger than a diameter of the third flat straight area.

5: The fan according to claim 1, wherein:
the constriction area is an arc or an arc chain formed by smooth connection of a plurality of arcs; or
the constriction area is a straight line or a polyline formed by a plurality of straight lines.

6: The fan according to claim 1, wherein:
the air impeller is disposed adjacent to the air inlet section, the air impeller comprises a wheel hub connected with an output shaft of a motor and a plurality of blades disposed on an outer wall of the wheel hub at equal intervals along a circumferential direction of the wheel hub, the number of the blades is n1;
wherein the blades are configured such that a section in the circumferential direction of the wheel hub is arc-shaped, and a chord length B corresponding to the section increases as a diameter D of the blade increases;
the number n1 of the blades, the chord length B and the diameter D of the blade satisfy the following relationship: 0.35<(B*n1/D)<0.48.

7: The fan according to claim 6, wherein:
the blade has a blade root connected to the wheel hub and a blade tip disposed away from the blade root; and wherein a gap between the blade tip and the inner wall of the air cylinder gradually decreases along the air inlet direction.

8: The fan according to claim 6, wherein:
the wheel hub is connected with the output shaft of the motor through a knurled nut;
wherein an outer diameter of the wheel hub is gradually increasing in the air inlet direction, and a projection of an outer peripheral surface of the wheel hub in the axial direction is an arc or a smooth arc chain composed of a plurality of arcs.

9: The fan according to claim 6, wherein:
the guide vane assembly is disposed adjacent to the air outlet section, the guide vane assembly comprises a motor fixing seat supporting the motor and guide vanes disposed on an outer wall of the motor fixing seat, the guide vanes are connected with the inner wall of the air cylinder so as to fix the motor to the air cylinder;
wherein the air cylinder, the motor fixing seat and the wheel hub are disposed coaxially.

10: A hair dryer, wherein the hair dryer comprises the fan according to claim 1.

11: A fan, comprising:
an air cylinder, an interior of the air cylinder being hollow along an axial direction of the air cylinder to form a hollow cavity extending through the air cylinder, the air cylinder having an air inlet and an air outlet; and
an air outlet hood detachably disposed on the air outlet, the air outlet hood being provided with an annular air outlet for air outlet;
wherein an outer ring and/or an inner ring of the annular air outlet is formed with an annular guide rib extending along a circumferential direction of the annular air outlet and extending toward the air inlet; the annular guide rib is configured to make an airflow cross section adjacent to the annular air outlet gradually decrease, so as to make an airflow in the air outlet hood cohesive, thereby increasing an air outlet speed of the annular air outlet.

12: The fan according to claim 11, wherein:
the annular guide rib disposed on the outer ring of the annular air outlet is a first annular guide rib, and the annular guide rib disposed on the inner ring of the annular air outlet is a second annular guide rib;
wherein along a direction from the air inlet to the air outlet, an inner diameter of the first annular guide rib is gradually decreasing, and an outer diameter of the second annular guide rib is gradually increasing.

13: The fan according to claim 12, wherein:
an inner wall of the first annular guide rib is provided with at least a first inclined region section which forms an included angle α with an axial direction of the air outlet hood, so as to make the airflow in the air outlet hood cohesive;
wherein a value range of the included angle α is: 0°≤α≤60°.

14: The fan according to claim 12, wherein:
an outer wall of the second annular guide rib is provided with at least a second inclined region section which forms an included angle β with an axial direction of the air outlet hood, so as to make the airflow in the air outlet hood cohesive;
wherein a value range of the included angle β is: 0°≤α≤12°.

15: The fan according to claim 11, wherein:
the air outlet hood has an inner end surface and an outer end surface disposed opposite to the inner end surface, the annular guide rib is provided on the inner end surface, a center of the outer end surface is provided with a groove which is configured for mounting an indicator light assembly; and wherein the annular air outlet is annularly distributed on an outer circumference of the groove.

16: The fan according to claim 15, wherein:
the indicator light assembly comprises a control panel and a light cover, the control panel is provided with an indicator light, the control board is disposed in the light cover and assembled with the light cover as a whole; and wherein the light cover is detachably disposed in the groove.

17: The fan according to claim 11, wherein:
an air nozzle is disposed at the air outlet, the air outlet has a first clamping structure, and the air nozzle has a second clamping structure matched with the first clamping structure; wherein after the air nozzle is clamped to the air outlet through the cooperation of the second clamping structure and the first clamping structure, the air nozzle is rotatable relative to the air cylinder.

18: The fan according to claim 17, wherein:
the first clamping structure comprises a flange formed at the air outlet and a rib formed on an outer periphery of an end face of the air outlet hood; wherein the flange grows inwardly along a radial direction of the air outlet, the rib grows along the axial direction of the air outlet and abuts against the flange, and an inner ring hole diameter of the flange is smaller than an inner ring hole diameter of the rib to form a snap space;
the second clamping structure comprises a clamping edge formed on the air nozzle, and the clamping edge is configured to mate with the snap space.

19: The fan according to claim 17, wherein:
curved surfaces constricted inwardly are symmetrically formed on a wall surface of the air nozzle, so that the air nozzle has an air outlet with a flat mouth and an air inlet with a round mouth;
the air nozzle comprises an inner shell and an outer shell, the outer shell is sleeved on an outer circumference of the inner shell; wherein a connection structure is provided on a region section of a round opening of the outer shell corresponding to the curved surfaces, and the connection structure is configured for ultrasonic welding the inner shell and the outer shell.

20: A hair dryer, comprising a fan, the fan comprising:
an air cylinder, an interior of the air cylinder being hollow along an axial direction of the air cylinder to form a hollow cavity extending through the air cylinder, the air cylinder having an air inlet and an air outlet; and
an air outlet hood detachably disposed on the air outlet, the air outlet hood being provided with an annular air outlet for air outlet;
wherein an outer ring and/or an inner ring of the annular air outlet is formed with an annular guide rib extending along a circumferential direction of the annular air outlet and extending toward the air inlet the annular guide rib is configured to make an airflow cross section adjacent to the annular air outlet gradually decrease, so as to make an airflow in the air outlet hood cohesive, thereby increasing an air outlet speed of the annular air outlet.
